(19) United States
(12) Patent Application Publication
(10) Pub. No.: US 2005/0166261 A1
(43) Pub. Date: Jul. 28, 2005

(54) System and method for network authentication of a data service offering

(75) Inventors: Philip Ted Kortum, Austin, TX (US); Marc Andrew Sullivan, Austin, TX (US)

Correspondence Address: TOLER & LARSON & ABEL L.L.P., 5000 PLAZA ON THE LAKE STE 265, AUSTIN, TX, 78746, US

(73) Assignee: SBC Knowledge Ventures, L.P.

(21) Appl. No.: 10/763,939

(22) Filed: Jan. 23, 2004

(51) Int. Cl. H04L 9/00; G06F 11/30

(52) U.S. Cl. 726/5; 713/155

(57) ABSTRACT

A system and method are disclosed for providing authentication services. A method incorporating teachings of the present disclosure may include receiving a common user credential from a user seeking access to an information network. In some embodiments, the common user credential may have been broadly assigned and may not effectively operate as a unique identifier for the user. A unique credential may be generated for the user at a network node and may include some piece of network specific information associated with or capable of uniquely identifying a connection being used by the user. The unique credential may then be considered in combination with the common user credential or in lieu of the common user credential when making an authentication decision for the user.

### FIELD OF THE INVENTION

The present disclosure relates generally to gaining access to data services, and more specifically to a system and method for network authentication of a data service offering.

### BACKGROUND

A network may be characterized by several factors like who can use the network, the type of traffic the network carries, the medium carrying the traffic, the typical nature of the network's connections, and the transmission technology the network uses. For example, one network may be public and carry circuit switched voice traffic while another may be private and carry packet switched data traffic. Whatever the make-up, most networks facilitate the communication of information between at least two nodes, and as such act as communication networks.

At a physical level, a communication network may include a series of nodes interconnected by communication paths. Gaining access to a network and/or the voice and data services available through the network often involves authentication. Typically, a user is prompted to enter credentials like a unique user identification (ID) and password combination whenever the user seeks network and/or service access. While this authentication step may help network operators and service providers create and maintain a secure network, the step also creates several potential problems. Users may forget passwords or user ID's. User ID selection may be overly burdensome. Whatever the challenge, the end result is often a frustrated user and an increased cost of operation for the network operator and/or service provider.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 presents a flow diagram for network-based authentication of an accessing device in accordance with the teachings of the present disclosure; and

FIG. 2 shows one embodiment of a network implemented system that incorporates teachings of the present disclosure to authenticate devices seeking access to a communication network.

### DETAILED DESCRIPTION OF THE DRAWINGS

Embodiments discussed below describe, in part, granting network access to a user in a transparent manner. From a high level, a system incorporating teachings of the present disclosure may effectively create a network log-in procedure that uniquely identifies the requesting device. In some embodiments, this authentication may occur without requiring the user seeking access to key-in or otherwise input user-specific credentials. In operation, a common username and password combination may be broadly assigned to more than one requestor device. This broadly assigned combination may be made unique for a given requesting device by replacing the combination or altering it with some network specific information that is unique to the requesting device or its connection. Using network specific information to make otherwise common credentials unique may provide several advantages to users, service providers, and network operators.

For example, a broadband cable network operator or an Asynchronous Digital Subscriber Line (ADSL) network operator may control access to the network using unique user keyed-in ID/password combinations. The use of these unique combinations may be employed, for example, as a part of using a Point to Point Protocol like the Point to Point Protocol over Ethernet (PPPoE). In practice, a PPPoE client may be executing on a user device and may pass a UserID/Password combination to a network access server (NAS), which may utilize a security server, such as a RADIUS server, to authenticate the user and authorize the requested access.

In some embodiments, authentication and authorization may be performed in a single step. When a user logs on to the network, a NAS may prompt the user for their user name and password. The NAS may then send the request to the security server. Depending on implementation detail, the NAS may include with the request a proposed configuration and/or some additional set of attributes for the user. The NAS may propose, for example, that the user be assigned a certain Internet Protocol (IP) address and subnet mask. The NAS request may also include information about the user's caller ID, the port the user is using, and/or some other attributes.

Based on the information in the request, the security server may return a response to the NAS, which may include a permit response, a deny response, or some other appropriate response. In the case of a permit response, the security server may also tell the NAS to apply other attributes to the user. For example, the security server may tell the NAS to use a different IP address, or to apply certain access filters or timeout values to the user.

Such an approach may do an admirable job of creating a secure network, enabling access control, preventing some problems associated with a Dynamic Host Control Protocol (DHCP) bridged network, and allowing service providers to track or manage the usage and behavior of a given user. In the systems and methodologies discussed below, some or all of the above-referenced authentication and authorization processes may occur with minimal user involvement. Many of the processes could, for example, occur in the network and transparently to the user—removing or at least limiting the opportunity for log-in failures caused by user error. The costs associated with failed log-ins can be very high, and avoiding these costs would benefit both the subscriber and the network operator. Each time user log-ins fail and/or users forget their username or password, a help desk provided by a network operator may receive a call from a subscriber. Not only is the subscriber frustrated by the experience, but the operator often expends considerable amounts of money as a result.

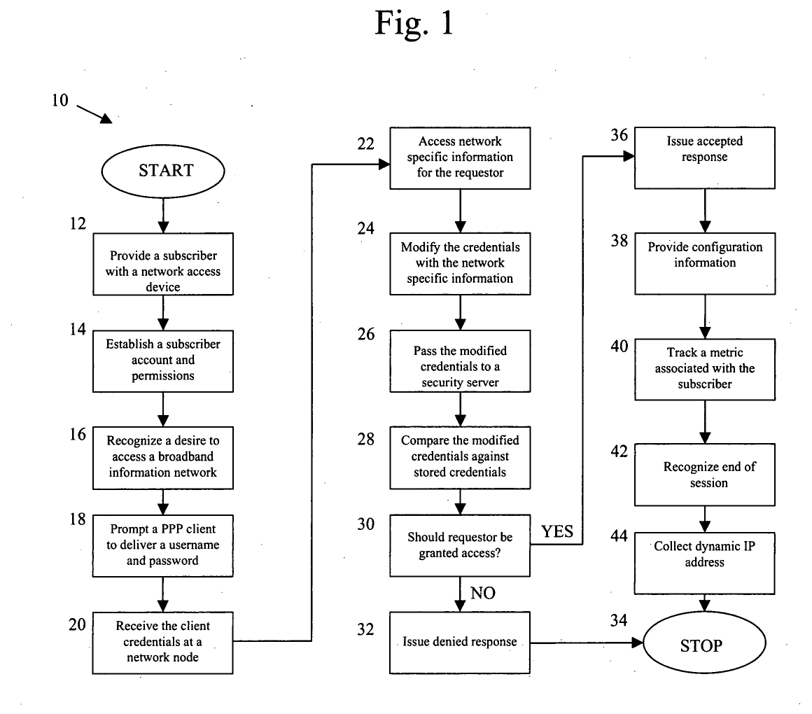

As mentioned above in the brief description of the drawings, FIG. 1 presents a flow diagram for a technique 10 of authenticating an accessing device in accordance with the teachings of the present disclosure. Technique 10 may, in some embodiments, authenticate a user in a manner that is device independent. It may not matter what device a user is employing. Technique 10 may rely more heavily on some network specific information that describes, for example, a characteristic, type, location, or make-up of the physical and/or virtual connection linking a given user to a network node tasked with performing an authorizing function.

Technique 10 may begin at step 12, at which point a user may be given a device that facilitates network access. The device could include, for example, a cable modem, an xDSL modem, and/or some electronic device capable of supporting execution of a PPPoE client. At step 14, a network operator may establish an account and associated permissions for the user. The account and permissions may “tell” network components to expect communications from the user and how to treat those communications.

At step 16, a desire to access an information network may be recognized. The recognition may occur, for example, within a computing device of the user or within the device provided at step 12. At step 18, a PPP client may be prompted to deliver a set of credentials to a remote authentication device. The PPP client may be a PPPoE client, and the communication of the credentials may be part of a log-in procedure employed when establishing a Point to Point connection.

At step 20, a network access request may be received. Receiving the request may occur, for example, at a network node like a Network Access Server (NAS) associated with the network operator. A component of the NAS and/or some other mechanism may access and retrieve some network specific information at step 22. The network specific information may identify or be associated with a physical or virtual link employed by the requesting device. In an xDSL implementation, the network information may include a unique circuit identification number for an xDSL line, a virtual path/virtual circuit identification associated with xDSL routing, and/or some other information capable of uniquely identifying the requestor. Depending on implementation detail, other and/or additional types of network information may be used.

At step 24, the credentials received from the requestor may be replaced, supplemented, and/or modified with the network specific information accessed at step 22. The modified credentials may then, at step 26, be passed along to a security server, which may be associated with the NAS referenced above. The security server may be a RADIUS server and/or some other security appliance. At step 28, the modified credentials may be compared against a set of stored credentials. The stored credentials may represent users who have access rights, and if the modified credentials can be found in the list of stored credentials, the requestor may be granted access to the requested information network. The decision whether or not to grant access may be made at step 30.

If the security server elects to deny access, technique 10 may advance to step 32 where a deny response may be issued to the requestor. Technique 10 may progress to stop at step 34 following the issuance of the deny response. If at step 30, the requestor is accepted, an accept or permit response may be issued to the requestor at step 36. At step 38, the requester may be provided with configuration information, and at step 40 a metric associated with the requestor's use of network access may be tracked.

At step 42, it may be recognized that the requesting device has ended its information network session, and at step 44, a dynamically assigned Internet Protocol (IP) address may be collected and/or added to a pool of available addresses. Technique 10 may then progress to stop at step 34.

As described above, technique 10 may not rely on a user to correctly key in a username and password. A system implementing technique 10 may not “care” what a user or a requesting device of that user “thinks” is the correct credentials for accessing a given information network. In some embodiments, information included as credentials in a request for network access may be stripped from the request and different credentials may be added in their place. As such, the authorization step may not involve authenticating the originally communicated credentials.

In practice, a system employing a technique like technique 10 may operate at a remote server or computing platform that executes instructions that effectuate the technique. In such a system, the remote computing platform may include a computer-readable medium containing computer-readable instructions capable of instructing the platform to receive a request for access to an information network. The request may include a credential such as a UserID/Password combination. The computer-readable medium may include additional instructions directing the platform to replace the credential received from a requesting device with a network generated credential that uniquely identifies a connection in use by the user seeking access to the information network. The platform may then be instructed to compare the network generated credential against a stored collection of acceptable credentials and to issue a permit response if the network generated credential is acceptable.

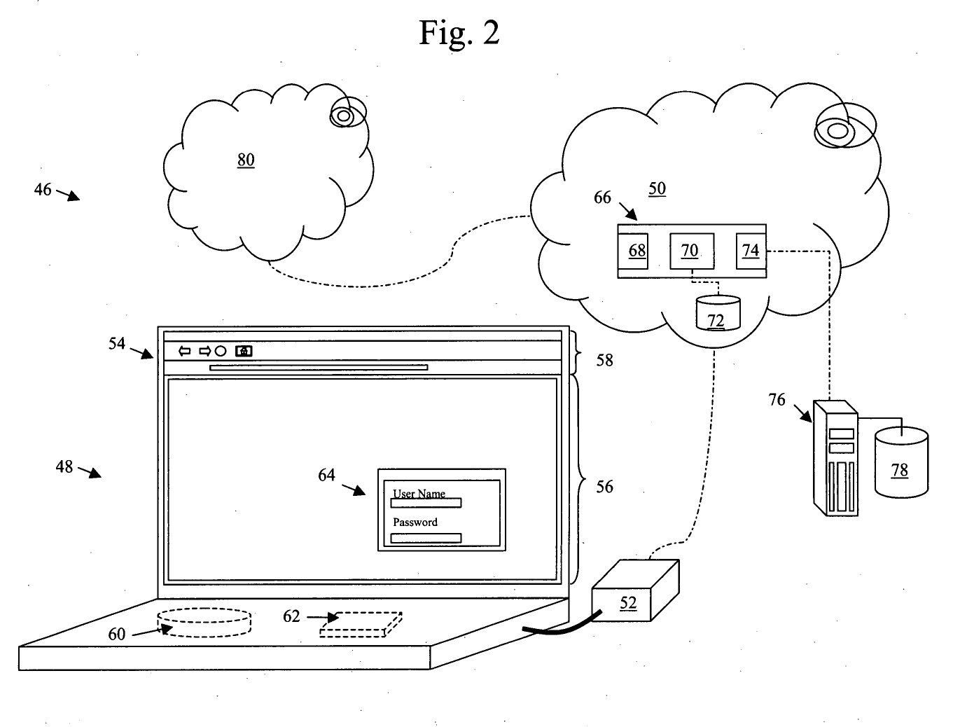

As mentioned above, FIG. 2 shows an embodiment of a network implemented system 46 that incorporates teachings of the present disclosure to authenticate end users seeking access to an information network, like the Public Internet, an Intranet, an Extranet, a Local Area Network, some other communication network, and/or some combination thereof. As shown, system 46 includes a laptop computer 48 that may be communicatively coupled to a service provider network 50. Network 50 may include, for example, a Public Switched Telephone Network (PSTN), a cable network, some xDSL infrastructure, a wireless network, and/or some other networking components capable of facilitating data communication. Whatever its make up, network 50 may be capable of communicating information. The communication could occur, for example, across dedicated circuits, as IP packets, and/or across an air interface.

As depicted, laptop 48 may communicate with a node of network 50 with the help of modem 52. In operation, a user may be presented with a display 54 that includes a browser window 56 and a browser bar 58. Launching a browser or other application may initiate a process whereby laptop 48 seeks access to network 50. In some embodiments, a PPPoE client stored in local memory 60 may be launched in connection with a user expressing a desire to access an information network. The PPPoE client may execute on processor 62 and may initiate presentation of a Graphical User Interface (GUI) element 64 within browser window 56.

GUI element 64 may prompt a user to enter or key-in a user name and password. These credentials may then be forwarded to an identification mechanism 66 associated with network 50. ID mechanism 66 may be a stand-alone computing platform. It may also be included in some other network node. In operation, the PPPoE client referenced above may request access to an information network and may include the user credentials in connection with making the request. An interface 68 of ID mechanism 66 may receive the request and may pass the request to a customizing engine 70.

Customizing engine 70 may strip the user credentials from the request and replace the stripped credentials with a piece of network specific information. The network specific information may uniquely identify the requestor and may be stored in a network repository 72. After modifying the request, customizing engine 70 may pass the request to an output device 74 that communicates the request to a security server 76. Security server 76 may then authenticate and authorize the user by comparing the modified credentials against a list of acceptable credentials located in network repository 78. If the modified credentials are acceptable, security server 76 may “allow” laptop 48 to communicate with an information network like Public Internet 80.

Communication between device 52 and a node of network 50 may take several forms. Communication may occur across dedicated circuits, in a packetized manner, across virtual connections, in a special data frequency band, across a wireline connection including copper, optical fiber, coaxial fiber, an air interface, and/or a combination thereof. An air interface may employ, for example, wireless techniques that utilize Radio Frequency (RF) communication. As such, a device like computer 48 may be capable of Radio Frequency communication that employs a 2.5G mobile technology like GPRS or EDGE. Computer 48 may also employ higher bandwidth offerings like 3G/UMTS. In some embodiments, computer 48 may communicate with a LAN node using a short-range or local wireless technology like 802.11, Wi-Fi, Bluetooth, and/or some other technique.

It should be understood that the mechanisms, computers, devices, engines, servers, and/or platforms, described herein, may take several different forms and may be stand alone and/or incorporated into several different pieces of equipment, like laptop computers, desktop computers, telephones, mainframes, PSTN switches, Ethernet switches, routers, gateways, hardware, firmware, software, work stations, other options having some level of computing capability, and/or a combination thereof. For example, various engines could be independent applications, could be independent servers, could be executing on different platforms, and/or could be executing on a single platform.

The methods and systems described herein provide for an adaptable implementation. Although certain embodiments have been described using specific examples, it will be apparent to those skilled in the art that the invention is not limited to these few examples. Note also, that although certain illustrative embodiments have been shown and described in detail herein, along with certain variants thereof, many other varied embodiments may be constructed by those skilled in the art.

The benefits, advantages, solutions to problems, and any element(s) that may cause any benefit, advantage, or solution to occur or become more pronounced are not to be construed as a critical, required, or essential feature or element of the present invention. Accordingly, the present invention is not intended to be limited to the specific form set forth herein, but on the contrary, it is intended to cover such alternatives, modifications, and equivalents, as can be reasonably included within the spirit and scope of the invention as provided by the claims below.

1. A method of network authentication comprising:
receiving a common user credential from a user seeking access to an information network;
generating a unique credential for the user that comprises network specific information associated with a connection of the user; and
considering the unique credential in connection with making an authentication decision for the user.

2. The method of claim 1, further comprising:
receiving the common user credential from a different user seeking access to the information network;
generating a different unique credential for the different user that comprises different network specific information; and
considering the different unique credential in connection with making an authentication decision for the different user.

3. The method of claim 1, wherein the connection of the user comprises an xDSL link.

4. The method of claim 1, wherein the connection of the user comprises a link at least partially supported by a cable modem.

5. The method of claim 1, further comprising utilizing a network node to generate the unique credential.

6. The method of claim 1, wherein the network specific information comprises a unique circuit identification number associated with an ADSL connection.

7. The method of claim 1, wherein the network specific information comprises a virtual circuit identification associated with ADSL routing.

8. The method of claim 1, further comprising tracking a metric associated with the user.

9. The method of claim 8, wherein the metric is selected from the group consisting of an access control metric, a payment metric, and a security metric.

10. The method of claim 1, further comprising utilizing a network node to generate the unique credential, wherein the network node comprises an authentication server and an interface operable to receive the common user credential.

11. The method of claim 1, further comprising:
determining that the user does not have access rights to the information network; and
initiating communication of a deny response.

12. The method of claim 1, wherein the network specific information comprises network generated information that is unique to a connection in use by the user.

13. The method of claim 1, wherein the network specific information comprises information that is unique to a physical location of the user.

14. An authentication system, comprising:
an interface operable to receive an authentication request from a PPPoE client of a given user;
a customizing engine communicatively coupled to the interface and operable to add a unique identifier for the given user to the authentication request; and
an output device communicatively coupled to the customizing engine and operable to output the unique identifier to an access engine for authentication of the given user.

15. The system of claim 14, further comprising a network node that comprises the interface, the customizing engine, and the output device.

16. The system of claim 14, further comprising the access engine, wherein the access engine is communicatively coupled to a repository comprising acceptable credentials, further wherein the access engine is operable to compare the unique identifier against the acceptable credentials as a part of granting access rights to the given user.

17. The system of claim 14, wherein the authentication request from the PPPoE client comprises an included identifier, further wherein the customizing engine is further operable to remove included identifier prior to an outputting of the authentication request to the access engine.

18. The system of claim 14, wherein the authentication request from the PPPoE client comprises an included identifier that does not uniquely identify the given user.

19. The system of claim 14, further comprising a piece of customer premises equipment comprising a broadband modem, the broadband modem operable to output the authentication request to the interface.

20. The system of claim 19, further comprising a service provider network node that comprises the interface, the customizing engine, and the output device.

21. The system of claim 20, further comprising:
a communication path operable to form at least a part of an interconnection between the broadband modem and the Public Internet; and
the access engine, wherein the access engine is communicatively coupled to a repository comprising acceptable credentials, further wherein the access engine is operable to compare the unique identifier against the acceptable credentials as a part of granting the given user an access right to the communication path.

22. The system of claim 21, wherein the unique identifier comprises a unique circuit identification number associated with an ADSL connection.

23. The system of claim 21, wherein the unique identifier comprises network generated information that is unique to a connection in use by the given user.

24. The system of claim 23, wherein the unique identifier does not uniquely identify the piece of customer premises equipment or the broadband modem.

25. A computer-readable medium having computer-readable data to receive a request for access to an information network, the request comprising a credential; to replace the credential with a network generated credential that uniquely identifies a connection in use by a user seeking access to the information network; to compare the network generated credential against a stored collection of acceptable credentials; and, to issue a permit response if the network generated credential is acceptable.

26. The computer-readable medium of claim 25, wherein the credential comprises a commonly assigned credential that does not uniquely identify a requestor.
